(19) United States
(12) Patent Application Publication
(10) Pub. No.: US 2026/0360234 A1
(43) Pub. Date: Nov. 12, 2026

(54) EXIT ALARM DEVICE

(71) Applicant: Frederick Taylor, Grand Rapids, MI (US)

(72) Inventor: Frederick Taylor, Grand Rapids, MI (US)

(21) Appl. No.: 19/202,407

(22) Filed: May 8, 2025

(51) Int. Cl. G08B 7/06; G08B 3/10; G08B 5/38; G08B 17/117

(52) U.S. Cl. CPC G08B 7/062; G08B 3/10; G08B 5/38; G08B 17/117

(57) ABSTRACT

An exit alarm device includes a housing, an exit sign, a carbon monoxide detector, a smoke detector, an audiovisual alarm system, a microprocessor, internal wiring, and an external wire. The exit sign is positioned in the front panel of the housing. Each of the carbon monoxide detector, the smoke detector, the audiovisual alarm system, the microprocessor, and the internal wiring is positioned in the housing. The microprocessor is connected to each of the carbon monoxide detector, the smoke detector, and the audiovisual alarm system to activate the audiovisual alarm system in response to smoke or carbon dioxide is detected. The internal wiring is connected to each of the exit sign, the microprocessor, the carbon monoxide detector, the smoke detector, and the audiovisual alarm system. The external wire is connected to the internal wiring. The external wire extends from the housing and is connectable to a building wiring.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to exit signs and more particularly pertains to a new exit alarm device that combines multiple devices into a single unit connectable by a single electrical wire to the wiring of a building. Buildings usually include lighted exit signs, smoke detectors, carbon monoxide detectors, and different types of audiovisual alarms. These devices usually are independent of one another and thus require independent wiring, which can make installation difficult, especially since many safety and building codes require such devices to be hardwired in a building's electrical system to ensure functionality. The new exit alarm device combines these different devices into a single unit with one external wire to conveniently connect to a building's electrical system.

### (2) Description of Related Art Including Information Disclosed Under 37 CFR 1.97 and 1.98

The prior art relates to exit signs. The prior art, as best understood, does not disclose an exit alarm device that includes a housing, an exit sign, a carbon monoxide detector, a smoke detector, an audiovisual alarm system, a microprocessor, internal wiring, and an external wire, wherein the internal wiring is positioned in the housing and is connected to each of the exit sign, the microprocessor, the carbon monoxide detector, the smoke detector, and the audiovisual alarm system. The external wire is connected to the internal wiring, extends from the housing, and is connectable to a building wiring.

### BRIEF SUMMARY OF THE INVENTION

An embodiment of the disclosure meets the needs presented above in a exit alarm device generally comprising a housing, an exit sign, a carbon monoxide detector, a smoke detector, an audiovisual alarm system, a microprocessor, internal wiring, and an external wire. The housing includes a front panel, a rear panel, and a perimeter wall. The exit sign is positioned in the front panel. The carbon monoxide detector is positioned in the housing. The smoke detector is positioned in the housing. The audiovisual alarm system is positioned in the housing. The microprocessor is positioned in the housing. The microprocessor is connected to each of the carbon monoxide detector, the smoke detector, and the audiovisual alarm system to activate the audiovisual alarm system in response to smoke or carbon dioxide is detected. The internal wiring is positioned in the housing and is connected to each of the exit sign, the microprocessor, the carbon monoxide detector, the smoke detector, and the audiovisual alarm system. The external wire is connected to the internal wiring. The external wire extends from the housing and is connectable to a building wiring.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of an exit alarm device according to an embodiment of the disclosure.

FIG. 2 is a bottom perspective view of an embodiment of the disclosure.

FIG. 3 is a front view of an embodiment of the disclosure.

FIG. 4 is a front view of an embodiment of the disclosure in use.

### DETAILED DESCRIPTION OF THE INVENTION

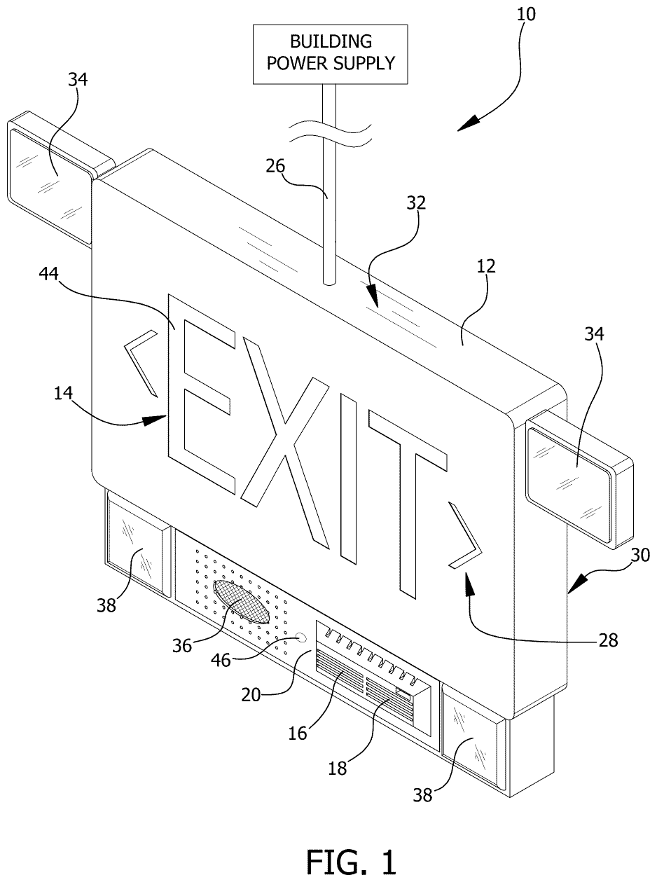

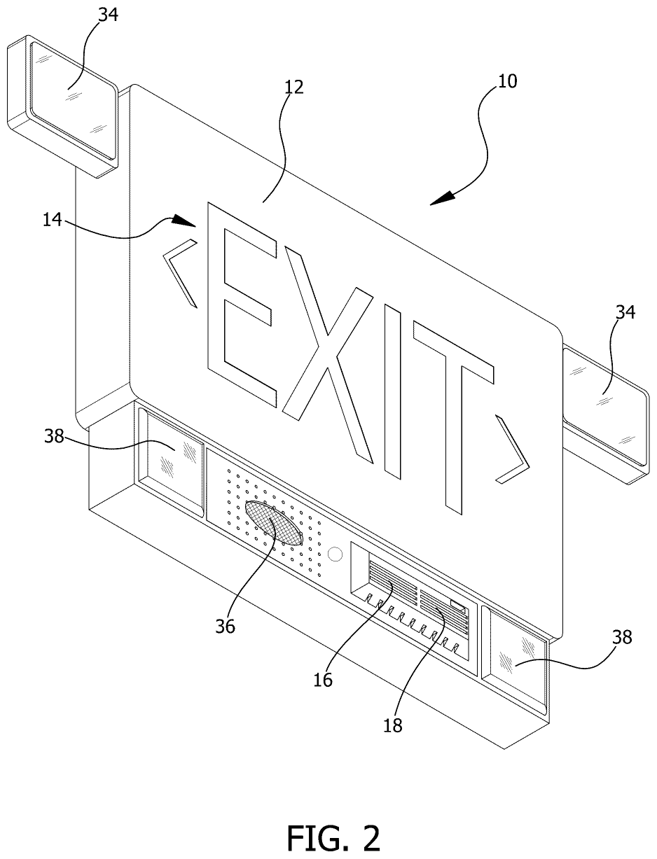

With reference now to the drawings, and in particular to FIGS. 1 through 4 thereof, a new exit alarm device embodying the principles and concepts of an embodiment of the disclosure and generally designated by the reference numeral 10 will be described.

As best illustrated in FIGS. 1 through 4, the exit alarm device 10 generally comprises a housing 12, an exit sign 14, a carbon monoxide detector 16, a smoke detector 18, an audiovisual alarm system 20, a microprocessor 22, internal wiring 24, and an external wire 26. The housing 12 includes a front panel 28, a rear panel 30, and a perimeter wall 32. The exit sign 14 is positioned in the front panel 28. The carbon monoxide detector 16 is positioned in the housing 12. The smoke detector 18 is positioned in the housing 12. The audiovisual alarm system 20 is positioned in the housing 12. The microprocessor 22 is positioned in the housing 12. The microprocessor 22 is connected to each of the carbon monoxide detector 16, the smoke detector 18, and the audiovisual alarm system 20 to activate the audiovisual alarm system 20 in response to smoke or carbon dioxide being detected. The internal wiring 24 is positioned in the housing 12 and is connected to each of the exit sign 14, the microprocessor 22, the carbon monoxide detector 16, the smoke detector 18, and the audiovisual alarm system 20. The external wire 26 is connected to the internal wiring 24. The external wire 26 extends from the housing 12 and is connectable to a building wiring or building power supply, as shown in FIG. 1.

The exit alarm device 10 also includes a flood light 34. The flood light 34 is mounted on the housing 12. The flood light 34 is connected to the microprocessor 22. The microprocessor 22 is designed to activate the flood light 34 in response to smoke or carbon dioxide is detected. In the exemplary embodiment in FIG. 1, there are a pair of the flood lights 34, one mounted on each corner of the housing 12. In the exemplary embodiment in FIG. 1, the audiovisual alarm system 20 also includes a photo eye 46 that senses when building lights are off, which in turn causes the microprocessor 22 to turn on the flood light 34 to provide guidance in the dark.

In the exemplary embodiment, the audiovisual alarm system 20 includes a speaker 36 designed to emit sounds. The sounds can be alarm sounds, words of instruction or warning, or a combination of the two, as is well known in the alarm arts. For example, in one possible embodiment, if smoke is detected, the microprocessor 22 could be programmed to emit a warning that smoke is detected or a specialized sound relating to the detection of smoke.

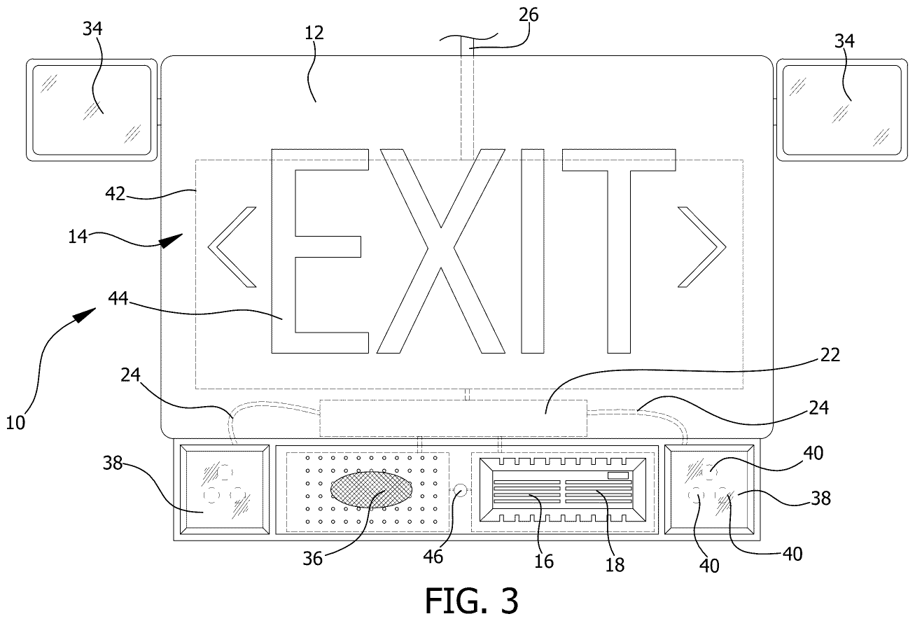

The audiovisual alarm system 20 also includes a light unit 38. The microprocessor 22 is designed to operate the light unit 38 intermittently to produce a flashing effect. In the exemplary embodiment in FIG. 3, the light unit 38 includes a plurality of colored lights 40 designed to emit different colors of light. The microprocessor 22 could operate each of these colored lights 40 independently, simultaneously, or in sequence to produce different effects, as is well known in the emergency lighting arts. In one possible embodiment, the light unit 38 emits only one color of light.

In the exemplary embodiment, the audiovisual alarm system 20 includes a pair of the light units 38, though one or more than two light units 38 could be included. The microprocessor 22 is designed to operate the light units 38 independently, simultaneously, or in sequence. In the exemplary embodiment, each of the pair of light units 38 is designed to emit a different color of light to indicate the detection of smoke, the detection of carbon monoxide, or the detection of both smoke and carbon monoxide. For example, one of the light units 38 may emit one color of light, such as red, to indicate smoke has been detected, and the other of the light units 38 may emit a different color of light, such as blue, to indicate carbon monoxide has been detected. If both smoke and carbon monoxide are detected, both light units 38 could be activated, either simultaneously or in an alternating manner.

In the exemplary embodiment, each of the audiovisual alarm system 20, the carbon monoxide detector 16, the smoke detector 18, and the light unit 38 is positioned below the exit sign 14, such as in a single container separate from the housing 12. However, these components could be positioned in virtually any location bordering the exit sign 14. The exit sign 14 includes a light source 42 to illuminate letters 44 of the exit sign. In one possible embodiment, the light source 42 is connected to the microprocessor 22, wherein the microprocessor 22 can cause intermittent operation of the light source 42 to cause flashing of the exit sign 14.

In one possible embodiment, the exit alarm device 10 is connected to an emergency alert system in a building to alert emergency personnel, such as firefighters or paramedics. In another possible embodiment, the exit alarm device 10 could include a wireless transceiver connected to the microprocessor 22 to wirelessly transmit a signal to an emergency alert system.

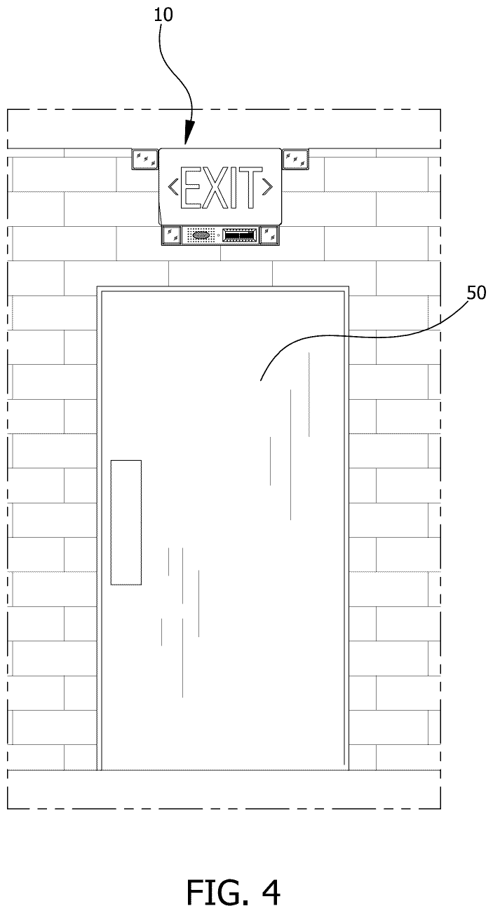

As shown in FIG. 4, the exit alarm device 10 can be mounted above a door 50, such as a fire door or emergency exit, of a building. The external wire 26 allows for easier installation for electricians and contractors. The exit alarm device 10 will detect carbon monoxide and/or smoke and alert persons accordingly while also indicating where to exit the building.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An exit alarm device comprising:
a housing, the housing including a front panel, a rear panel, and a perimeter wall;
an exit sign, the exit sign being positioned in the front panel;
a carbon monoxide detector, the carbon monoxide detector being positioned in the housing;
a smoke detector, the smoke detector being positioned in the housing;
an audiovisual alarm system, the audiovisual alarm system being positioned in the housing;
a microprocessor, the microprocessor being positioned in the housing, the microprocessor being connected to each of the carbon monoxide detector, the smoke detector, and the audiovisual alarm system to activate the audiovisual alarm system in response to smoke or carbon dioxide being detected;
internal wiring, the internal wiring being positioned in the housing and being connected to each of the exit sign, the microprocessor, the carbon monoxide detector, the smoke detector, and the audiovisual alarm system; and
an external wire, the external wire being connected to the internal wiring, the external wire extending from the housing and being connectable to a building wiring.

2. The exit alarm device of claim 1, further including a flood light, the flood light being mounted on the housing, the flood light being connected to the microprocessor, the microprocessor being configured to activate the flood light in response to smoke or carbon dioxide being detected.

3. The exit alarm device of claim 1, wherein the audiovisual alarm system includes a speaker configured to emit sounds.

4. The exit alarm device of claim 1, wherein:
the audiovisual alarm system includes a light unit;
the microprocessor is configured to operate the light unit intermittently to produce a flashing effect.

5. The exit alarm device of claim 4, wherein the light unit includes a plurality of colored lights configured to emit different colors of light.

6. The exit alarm device of claim 1, wherein:
the audiovisual alarm system includes a pair of the light units; and
the microprocessor is configured to operate the light units independently, simultaneously, or in sequence.

7. The exit alarm device of claim 6, wherein each of the pair of light units is configured to emit a different color of light to indicate the detection of smoke, the detection of carbon monoxide, or the detection of both smoke and carbon monoxide.

8. The exit alarm device of claim 1, wherein each of the audiovisual alarm system, the carbon monoxide detector, the smoke detector, and the light unit is positioned below the exit sign.

9. The exit alarm device of claim 1, wherein:
the exit sign includes a light source to illuminate letters of the exit sign;
the light source is connected to the microprocessor; and
the microprocessor is configured to operate the light source intermittently to cause flashing of the exit sign.

10. The exit alarm device of claim 2, wherein the audiovisual alarm system includes a speaker configured to emit sounds.

11. The exit alarm device of claim 10, wherein:
the audiovisual alarm system includes a light unit;
the microprocessor is configured to operate the light unit intermittently to produce a flashing effect.

12. The exit alarm device of claim 11, wherein the light unit includes a plurality of colored lights configured to emit different colors of light.

13. The exit alarm device of claim 12, wherein:
the audiovisual alarm system includes a pair of the light units; and
the microprocessor is configured to operate the light units independently, simultaneously, or in sequence.

14. The exit alarm device of claim 13, wherein each of the pair of light units is configured to emit a different color of light to indicate the detection of smoke, the detection of carbon monoxide, or the detection of both smoke and carbon monoxide.

15. The exit alarm device of claim 14, wherein each of the audiovisual alarm system, the carbon monoxide detector, the smoke detector, and the light unit is positioned below the exit sign.

16. The exit alarm device of claim 15, wherein:
the exit sign includes a light source to illuminate letters of the exit sign;
the light source is connected to the microprocessor; and
the microprocessor is configured to operate the light source intermittently to cause flashing of the exit sign.
